(19) United States
(12) Patent Application Publication
(10) Pub. No.: US 2006/0268119 A1
(43) Pub. Date: Nov. 30, 2006

(54) Television camera, television camera system and image pickup control method

(76) Inventor: Akiyoshi Sugawara, Kodaira (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/441,014

(22) Filed: May 26, 2006

(30) Foreign Application Priority Data
May 27, 2005 (JP) 2005-155305

(51) Int. Cl. H04N 9/73

(52) U.S. Cl. 348/223.1

(57) ABSTRACT

A television camera includes a clock circuit, a white balance memory circuit for storing correction values of a white balance correction circuit together with the acquisition time point thereof obtained from the clock circuit, a level detection circuit for detecting signal levels outputted from a plurality of image pickup devices, an illumination characteristic memory circuit for storing wavelength characteristics of a plurality of illumination lamps, and an illumination detection circuit for identifying kind of illumination on the basis of the signal levels detected by the detection circuit and the wavelength characteristics of the illumination lamps stored in the illumination characteristic memory circuit. The correction values of the white balance correction circuit are modified based on an output of the illumination detection circuit and an output of the white balance memory circuit.

### INCORPORATION BY REFERENCE

The present application claims priority from Japanese application JP 2005-155305 filed on May 27, 2005, the content of which is hereby incorporated by reference into this application.

### BACKGROUND OF THE INVENTION

The present invention relates to white balance of a television camera and more particularly to technique of modifying a white balance correction value in accordance with illumination light in a monitoring television camera automatically.

In a conventional television camera, light incident from an object to be imaged is separated into red (R), green (G) and blue (B) light of the three primary colors by a color separation prism and converted into electrical signals by three image pickup devices. The electrical signals are subjected to peak detection, average detection and divided area detection by detection means to detect an image in a part near to white from the object. Then, amplification factors of amplifiers in RGB image signal processing systems are controlled so that the image in the part becomes white to thereby realize automatic adjustment of white balance. Reference may be made to JP-A-10-327421, for example.

### SUMMARY OF THE INVENTION

In the conventional television camera, when the automatic adjustment of white balance is made under the surroundings where illumination conditions are varied, the camera cannot be sometimes judged automatically whether the color of the object imaged is the inherent color of the object or is influenced by the illumination. As a result, the color of the object that is white is sometimes not regarded as white due to influence of illumination, so that the white balance is not operated effectively and conversely even if the object is colored, the color information is sometimes lost. due to the automatic adjustment of white balance.

Accordingly, it is an object of the present invention to realize the reproducibility of color always stably even if the illumination conditions are varied.

It is another object of the present invention to provide a television camera that can realize the reproducibility of color near to the daytime even in the night and is suitable for 24-hour continuous monitoring.

According to an aspect of the present invention, the television camera comprises a color separation optical element for color-separating light incident from an image pickup lens into light of at least three colors, a plurality of image pickup devices for converting the color-separated light into electrical image signals to be outputted, a white balance correction circuit for correcting signal levels of the image signals of three colors to be the same signal level, a clock circuit for generating or acquiring time or time point, a white balance memory circuit for storing correction values of the white balance correction circuit together with the acquisition time thereof obtained from the clock circuit, a level detection circuit for detecting signal levels of the image signals produced from the plurality of image pickup devices, an illumination characteristic memory circuit for storing wavelength characteristics of a plurality of illumination lamps, and an illumination detection circuit for identifying kind of illumination on the basis of the signal levels detected by the level detection circuit and the wavelength characteristics of the illumination lamps stored in the illumination characteristic memory circuit, whereby the correction values of the white balance correction circuit are modified on the basis of an output of the illumination detection circuit and an output of the white balance memory circuit.

According to another aspect of the present invention, the television camera comprises an image pickup device for converting light incident from an image pickup lens into an electrical color image signal to be outputted, a separation circuit for separating the color image signal into red, green and blue image signals, a white balance correction circuit for correcting signal levels of the red, green and blue image signals to be the same signal level, a clock circuit for generating or acquiring time or time point, a white balance memory circuit for storing correction values of the white balance correction circuit together with acquisition time point thereof from the clock circuit, a level detection circuit for detecting signal levels of the red, green and blue image signals produced from the color separation circuit, an illumination characteristic memory circuit for storing wavelength characteristics of a plurality of illumination lamps, and an illumination detection circuit for identifying kind of illumination on the basis of the signal levels detected by the detection circuit and the wavelength characteristics of the illumination lamps stored in the illumination characteristic memory circuit, whereby the correction values of the white balance correction circuit are modified on the basis of an output of the illumination detection circuit and an output of the white balance memory circuit.

According to still another aspect of the present invention, the television camera system further comprises a pan and tilt head on which the television camera is mounted and an image pickup zoom lens. The white balance memory circuit further stores a pan angle and a tilt angle of the pan and tilt head and a zoom magnification of the image pickup zoom lens.

The television camera of an embodiment comprises switches for switching red, green and blue image signals outputted from the image pickup devices to be supplied to an image processing circuit and which are switched by the output of the illumination detection circuit.

According to a still further aspect of the present invention, the image pickup control method in the television camera including one or a plurality of image pickup devices for producing image signals of three colors and a white balance correction circuit supplied with the image signals of three colors, comprises taking an image of an object to be imaged by the image pickup devices, identifying kind of illumination illuminating the object by an illumination detection unit, modifying correction values of the white balance correction circuit in accordance with the identified kind of illumination, and subjecting corrected image signals to predetermined image processing to produce an image output signal.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram schematically illustrating an embodiment of a television camera according to the present invention;

FIG. 2 is a memory map showing correction values of white balance stored in a memory of FIG. 1;

FIG. 3 is a memory map showing illumination characteristics stored in the memory of FIG. 1;

FIGS. 4A and 4B are diagrams illustrating spectral characteristic of camera and colors seen by human eyes;

FIG. 5 is a block diagram schematically illustrating an embodiment of a television camera system according to the present invention;

FIG. 6 is a memory map explaining the contents stored in a memory of FIG. 5;

FIG. 7 is a diagram explaining the contents displayed in a monitor of FIG. 5; and

FIG. 8 is a block diagram schematically illustrating another embodiment of a television camera according to the present invention.

### DESCRIPTION OF THE EMBODIMENTS

Embodiments of the present invention are now described with reference to the accompanying drawings. The like elements are designated by like reference numerals.

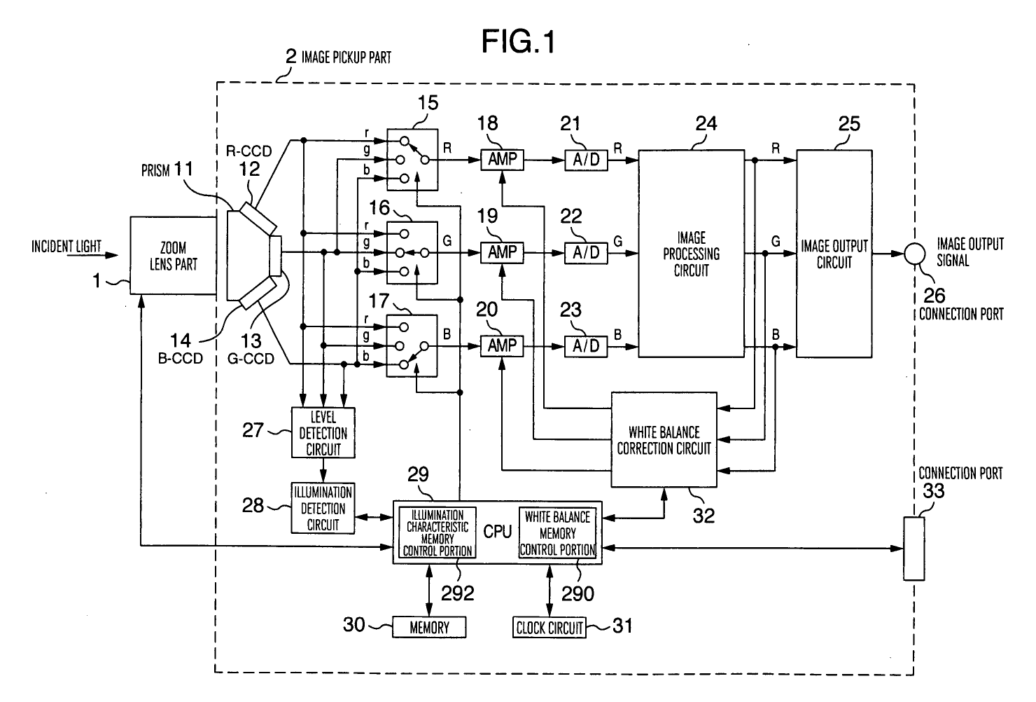

Referring now to FIG. 1, an embodiment of a television camera according to the present invention is described.

FIG. 1 is a block diagram schematically illustrating the embodiment of the television camera according to the present invention. In FIG. 1, numeral 1 denotes a zoom lens part including a zoom mechanism for focusing incident light and numeral 2 denotes an image pickup part for converting light incident from the zoom lens part 1 into an image signal.

In the image pickup part 2, numeral 11 denotes a prism for separating light incident from the lens part 1 into the three primary colors of red light, green light and blue light, for example, 12 an R-CCD for picking up the red light separated by the prism 11, 13 a G-CCD for picking up the green light separated by the prism 11, and 14 is a B-CCD for picking up the blue light separated by the prism 11. Numerals 15, 16 and 17 denote switches each selecting an image signal from image signals outputted from R-CCD 12, G-CCD 13 and B-CCD 14. Numeral 18 denotes an amplifier (hereinafter abbreviated as AMP 18) for amplifying an image signal outputted from the switch 15 to a predetermined level, 19 an amplifier (hereinafter abbreviated as AMP 19) for amplifying an image signal outputted from the switch 16 to a predetermined level, and 20 an amplifier (hereinafter abbreviated as AMP 20) for amplifying an image signal outputted from the switch 17 to a predetermined level. Numeral 21 denotes an A-D (analog-to-digital) converter for converting an image signal outputted from the AMP 18 into a digital signal, 22 an A-D converter for converting an image signal outputted from the AMP 19 into a digital signal, and 23 an A-D converter for converting an image signal outputted from the AMP 20 into a digital signal. Numeral 24 denotes an image processing circuit for subjecting the digital image signals of R (Red), G (Green) and B (Blue) outputted from the A-D converters 21, 22 and 23, respectively, to processing such as color correction and contour emphasis. Numeral 25 denotes an image output circuit for converting signals supplied from the image processing circuit 24 into a signal of predetermined standard to be outputted, and 26 a connection port for outputting a predetermined image signal from the image output circuit 25. Numeral 27 denotes a level detection circuit for detecting levels of the image signals outputted from R-CCD 12, G-CCD 13 and B-CCD 14, 28 an illumination detection circuit for detecting kind of illumination of the incident light from an output of the level detection circuit 27, and 29 a central processing unit (CPU) for controlling circuits constituting the image pickup part 2. Numeral 30 denotes a memory for storing adjustment values and information of the circuits of the image pickup part 2, 31 a clock circuit for generating or acquiring the time point, 32 a white balance correction circuit for detecting an image in a part near to white from image signal levels of the digital image signals of R, G and B outputted from the image processing circuit 24 and outputting correction signals for modifying the amplification factors of the AMPs 18, 19 and 20 so that the image in the part near to white becomes white, and 33 a connection port for connecting the image pickup part 2 to an external apparatus. The CPU 29 includes a white balance memory control portion (memory circuit) 290 for controlling to store correction values in the white balance correction circuit 32 together with the acquisition time point thereof obtained from the clock circuit 31 in the memory 30 and an illumination characteristic memory control portion (memory circuit) 292 for controlling to store wavelength characteristics of a plurality of illumination lamps in the memory 30. The white balance memory control portion 290 and the illumination characteristic memory control portion 292 may be provided independently of the CPU 290.

Operation of the embodiment of the present invention is now described with reference to FIGS. 1 to 3.

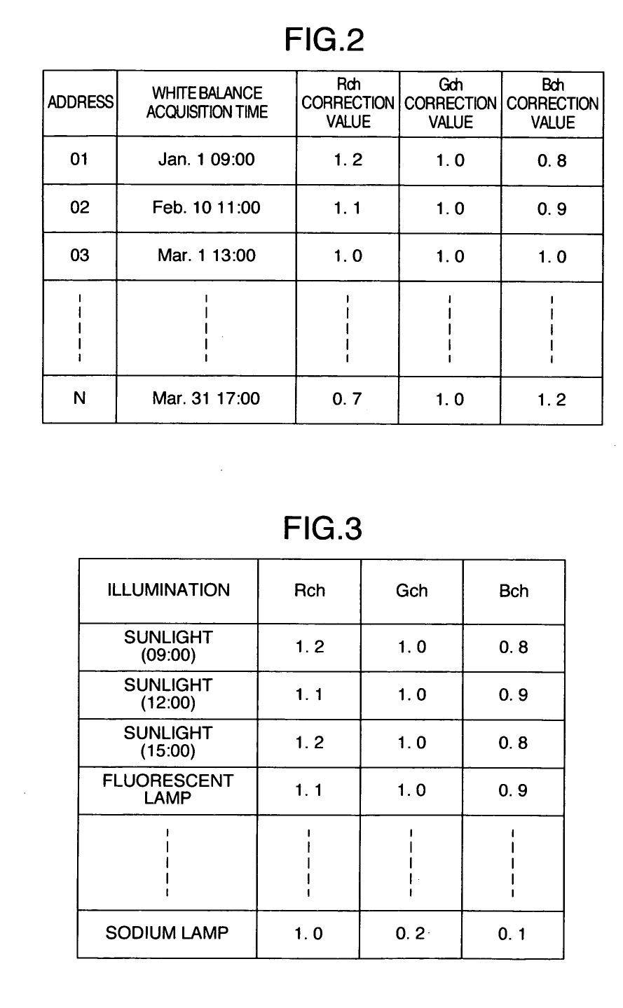

FIG. 2 is a memory map showing correction values of white balance stored in the memory 30 and FIG. 3 is also a memory map showing illumination characteristics stored in the memory 30. Data of the illumination characteristics shown in FIG. 3 is previously stored in the memory 30. The contents shown in FIGS. 2 and 3 may be stored in the memory 30 in response to instructions of an operator of the television camera or may be automatically acquired during operation of the television camera and stored in the memory 30. Any of data stored in the memory can be used later as the need arises.

Referring now to FIG. 1, description is made to the case where illumination of incident light is made by sunlight. Incident light enters the zoom lens part 1. The incident light passing through the zoom lens part 1 enters the prism 11. The light entering the prism 11 is separated into red, green and blue light, so that the red light enters the R-CCD 12, the green light enters the G-CCD 13 and the blue light enters the B-CCD 14. The R-CCD 12 converts the red light entered therein into an electrical signal to be supplied to the switches 15, 16 and 17 and the level detection circuit 27 as an image signal r. The G-CCD 13 converts the green light entered therein into an electrical signal to be supplied to the switches 15, 16 and 17 and the level detection circuit 27 as an image signal g. The B-CCD 14 converts the blue light entered therein into an electrical signal to be supplied to the switches 15, 16 and 17 and the level detection circuit 27 as an image signal b. The level detection circuit 27 detects a signal level ratio from the image signals r, g and b entered therein and supplies the detection result thereof to the illumination detection circuit 28. The illumination detection circuit 28 compares the detection result supplied from the level detection circuit 27 and the illumination characteristic data stored in the memory 30 and shown in FIG. 3 with data inputted through the CPU 29 to identify that the illumination of the incident light is made by sunlight and supplies the identification result thereof to the CPU 29. The illumination detection circuit 28 reads out data nearest to the output result of the level detection circuit 27 from the memory 30 to identify the illumination when data of the illumination light corresponding to the output result of the level detection circuit 27 is not stored in the memory 30. The CPU 29 supplies an instruction for the image signal to be selected to the switches 15, 16 and 17 on the basis of the identification result of the illumination outputted from the illumination detection circuit 28. Since the output of the illumination detection circuit 28 indicates that the illumination is made by sunlight, the CPU 29 supplies selection instructions of the image signals r, g and b to the switches 15, 16 and 17, respectively, so as to make ordinary white balance correction. An image signal R outputted from the switch 15 is amplified to a predetermined level by the AMP 18 and converted into a digital signal by the A-D converter 21 to be inputted to the image processing circuit 24. An image signal G outputted from the switch 16 is amplified to a predetermined level by the AMP 19 and converted into a digital signal by the A-D converter 22 to be inputted to the image processing circuit 24. An image signal B outputted from the switch 17 is amplified to a predetermined level by the AMP 20 and converted into a digital signal by the A-D converter 23 to be inputted to the image processing circuit 24. The image processing circuit 24 subjects the inputted image signals R, G and B to processing such as color correction and contour emphasis to be supplied to the image output circuit 25 and the white balance correction circuit 32. The image output circuit 25 converts the signals supplied from the image processing circuit 24 into image signal of predetermined standard to be outputted from the connection port 26. The white balance correction circuit 32 detects an image in a part near to white from the image signal levels of the digital image signals of R, G and B outputted from the image processing circuit 24 and outputs correction signals for modifying the amplification factors of the AMPs 18, 19 and 20 so that the image in the part near to white becomes white. The white balance correction circuit 32 itself is well-known as disclosed in JP-A-2000-134635, for example. The “image in the part near to white” may be extracted by taking out an image part having the range of 80 to 100%, for example, in a predetermined peak value of a brightness signal, for example.

The operator of the television camera inputs a store instruction signal to the connection port 33 by means of an operation unit not shown in order to store the correction values outputted from the white balance correction circuit 32 together with the time in the memory 30. The store instruction signal inputted to the connection port 33 is supplied to the CPU 29. The white balance memory control portion 290 of the CPU 29 acquires the time signal from the clock circuit 31 and the correction signals from the white balance correction circuit 32 in response to the store instruction signal to be stored in the memory 30. An example of the contents stored in the memory 30 is shown in FIG. 2. For example, the CPU 29 stores 09:00 on January 1 corresponding to the time that the correction values of white balance are acquired, 1.2 for Rch (red image signal) correction value of white balance, 1.0 for Gch (green image signal) correction value of white balance and 0.8 for Bch (blue image signal) correction value of white balance in address 01 of the memory 30. The reason why the date and time are stored is that color temperature information of sunlight is obtained from the time since the color temperature of sunlight is different depending on the season and weather even at the same time. The correction values at various acquisition times stored in the memory 30 can be read out to be used freely as the need arises.

In the embodiment, the contents shown in FIG. 2 are stored in the memory 30 in response to the instruction of the operator of the television camera, although correction value data for R, G and B channels may be acquired automatically during operation of the television camera to be stored in the memory 30 instead.

Operation for making coloring of the image signal outputted from the image pickup part 2 equal to that gotten by sunlight in the day when the illumination is changed to a fluorescent lamp in the night is now described.

The operator of the television camera inputs an instruction signal for making coloring of the image signal in the night equal to that gotten by sunlight in the day to the connection port 33 by means of the operation unit not shown in order to make coloring of the image signal outputted from the image pickup part 2 equal to that gotten by illumination of sunlight in the day. The instruction signal inputted to the connection port 33 is supplied to the CPU 29. Alternatively, the illumination detection circuit 28 which detects that the illumination is changed to a fluorescent lamp may automatically input the instruction signal to the CPU 29. The CPU 29 reads out data stored in address 02, for example, from the memory 30 in response to the inputted instruction signal and supplies the data to the white balance correction circuit 32. The data stored in address 02 are 1.1, 1.0 and 0.9 for Rch, Gch and Bch correction values acquired at 11 a.m. on February 10. As in the alternative method described above, if it is adapted that the illumination detection circuit 28 which detects that the illumination is changed to a fluorescent lamp automatically inputs the instruction signal to the CPU 29, it is possible to make continuous monitoring with natural coloring of the image signal during 24 hours without the operator's participation or intervention. In this case, an address from which data is to be read out may be set previously.

Operation of the image pickup part 2 is now described.

Incident light in case where the illumination is made by a fluorescent lamp enters the zoom lens part 1. The incident light passing through the zoom lens part 1 enters the prism 11. The light entering the prism 11 is separated into red, green and blue light, so that the red light enters the R-CCD 12, the green light enters the G-CCD 13 and the blue light enters the B-CCD 14. The R-CCD 12 converts the red light entered therein into an electrical signal to be supplied to the switches 15, 16 and 17 and the level detection circuit 27 as an image signal r. The G-CCD 13 converts the green light entered therein into an electrical signal to be supplied to the switches 15, 16 and 17 and the level detection circuit 27 as an image signal g. The B-CCD 14 converts the blue light entered therein into an electrical signal to be supplied to the switches 15, 16 and 17 and the level detection circuit 27 as an image signal b. The level detection circuit 27 detects a signal level ratio from the image signals r, g and b supplied thereto and supplies the detection result thereof to the illumination detection circuit 28. The illumination detection circuit 28 compares the detection result supplied from the level detection circuit 27 and the illumination characteristic data stored in the memory 30 and shown in FIG. 3 with data inputted through the CPU 29 to identify that the illumination of the incident light is made by a fluorescent lamp and supplies the identification result thereof to the CPU 29. The CPU 29 supplies an instruction for the image signal to be selected to the switches 15, 16 and 17 on the basis of the identification result of the illumination outputted from the illumination detection circuit 28. Since the output of the illumination detection circuit 28 indicates that the illumination is made by the fluorescent lamp, the CPU 29 supplies selection instructions of the image signals r, g and b to the switches 15, 16 and 17, respectively. An image signal R outputted from the switch 15 is amplified to a predetermined level by the AMP 18 and converted into a digital signal by the A-D converter 21 to be inputted to the image processing circuit 24. An image signal G outputted from the switch 16 is amplified to a predetermined level by the AMP 19 and converted into a digital signal by the A-D converter 22 to be inputted to the image processing circuit 24. An image signal B outputted from the switch 17 is amplified to a predetermined level by the AMP 20 and converted into a digital signal by the A-D converter 23 to be inputted to the image processing circuit 24. The image processing circuit 24 subjects the inputted image signals R, G and B to processing such as color correction and contour emphasis to be supplied to the image output circuit 25 and the white balance correction circuit 32. The image output circuit 25 converts the signals supplied from the image processing circuit 24 into image signal of predetermined standard to be outputted from the connection port 26. The white balance correction circuit 32 detects an image in a part near to white from the image signal levels of the digital image signals of R, G and B outputted from the image processing circuit 24 and outputs correction signals for modifying the amplification factors of the AMPs 18, 19 and 20 in accordance with data in the address 02 read out from the memory 30 through the CPU 29 so that the image in the part near to white gets the same coloring as that gotten by the illumination of sunlight. By repeating a series of modification operation of the amplification factors of the AMPs 18, 19 and 20, the digital image signals of R, G and B outputted from the image processing circuit 24 can get the same coloring as that gotten by the illumination of sunlight.

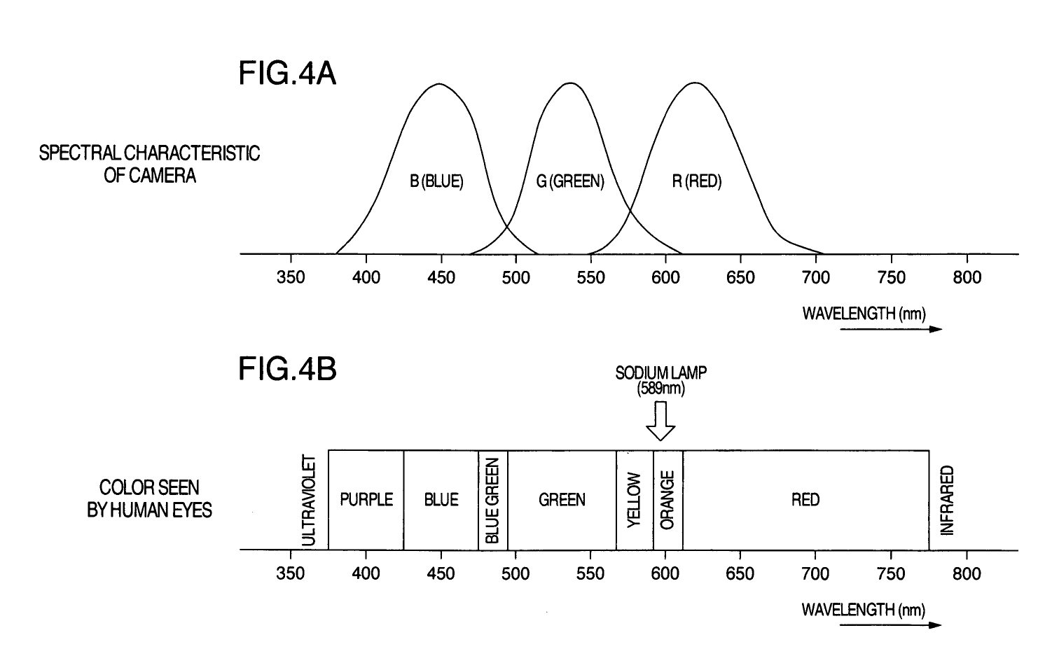

Referring to FIGS. 1 to 4A and 4B, operation of the image pickup part 2 for making coloring of the image signal outputted from the image pickup part 2 equal to the same orange as that gotten by the illumination when the illumination is changed to a sodium lamp in the night is now described. FIGS. 4A and 4B show the relation between spectral characteristic of the camera and colors seen by human eyes.

FIG. 4B shows the relation between wavelength and color of light seen by human eyes. FIG. 4A shows the spectral characteristic of the camera. The sodium lamp has the wavelength characteristic of emitting a single-wavelength light having a peak at about 589 nm as shown in FIG. 4B. When light emitted by the sodium lamp is seen by human eyes, it is orange, although when it is imaged by the camera, the greater part of the image is red and a few part is green as apparent from FIG. 4A. Accordingly, when the image signal outputted from the camera is displayed in a display such as a monitor, the whole display screen is red and is different from the color seen by human eyes.

As described above, one object of the present invention is to improve the color reproducibility of the television camera. Now, improvement of the color reproducibility is described with reference to FIGS. 1, 2 and 3.

In FIG. 1, incident light in case where illumination is made by a sodium lamp enters the zoom lens part 1. The incident light passing through the zoom lens part 1 enters the prism 11. The light entering the prism 11 is separated into red, green and blue light, so that the red light enters the R-CCD 12, the green light enters the G-CCD 13 and the blue light enters the B-CCD 14. The R-CCD 12 converts the red light entered therein into an electrical signal to be supplied to the switches 15, 16 and 17 and the level detection circuit 27 as an image signal r. The G-CCD 13 converts the green light entered therein into an electrical signal to be supplied to the switches 15, 16 and 17 and the level detection circuit 27 as an image signal g. The B-CCD 14 converts the blue light entered therein into an electrical signal to be supplied to the switches 15, 16 and 17 and the level detection circuit 27 as an image signal b. The level detection circuit 27 detects a signal level ratio from the image signals r, g and b supplied thereto and supplies the detection result thereof to the illumination detection circuit 28. The illumination detection circuit 28 compares the detection result supplied from the level detection circuit 27 and the illumination characteristic data stored in the memory 30 and shown in FIG. 3 with data inputted through the CPU 29 to identify that the illumination of the incident light is made by a sodium lamp and supplies the identification result thereof to the CPU 29. The CPU 29 supplies an instruction for the image signal to be selected to the switches 15, 16 and 17 on the basis of the identification result of the illumination outputted from the illumination detection circuit 28. Since the output of the illumination detection circuit 28 indicates that the illumination is made by the sodium lamp, the CPU 29 supplies selection instructions of the image signal r to the switches 15, 16 and 17. An image signal R outputted from the switch 15 is amplified to a predetermined level by the AMP 18 and converted into a digital signal by the A-D converter 21 to be inputted to the image processing circuit 24. An image signal G outputted from the switch 16 is amplified to a predetermined level by the AMP 19 and converted into a digital signal by the A-D converter 22 to be inputted to the image processing circuit 24. An image signal B outputted from the switch 17 is amplified to a predetermined level by the AMP 20 and converted into a digital signal by the A-D converter 23 to be inputted to the image processing circuit 24. The image processing circuit 24 subjects the inputted image signals R, G and B to processing such as color correction and contour emphasis to be supplied to the image output circuit 25 and the white balance correction circuit 32. The image output circuit 25 converts the signals supplied from the image processing circuit 24 into image signal of predetermined standard to be outputted from the connection port 26. The white balance correction circuit 32 reads out data of the sodium lamp shown in FIG. 3 and data in address 02 shown in FIG. 2, for example, from the memory 30 through the CPU 29 to produce new correction values for the sodium lamp in order to make coloring of the digital image signals of R, G and B outputted from the image processing circuit 24 equal to that gotten by the illumination of the sodium lamp. The new Rch correction value is equal to Rch correction value 1.1×1.0 for Rch of sodium lamp=1.1, the new Gch correction value is equal to Gch correction value 1.0×0.2 for Gch of sodium lamp=0.2, and the new Bch correction value is equal to Bch correction value 0.9×0.1 for Bch of sodium lamp=0.09. The white balance correction circuit 32 outputs the correction signals for modifying the amplification factors of the AMPs 18, 19 and 20 so that the digital image signals of R, G and B outputted from the image processing circuit 24 have the ratio of the data of the sodium lamp in accordance with the new correction values. By repeating a series of modification operation of the amplification factors of the AMPs 18, 19 and 20, the digital image signals of R, G and B outputted from the image processing circuit 24 can get the same coloring as that gotten by the illumination made by the sodium lamp.

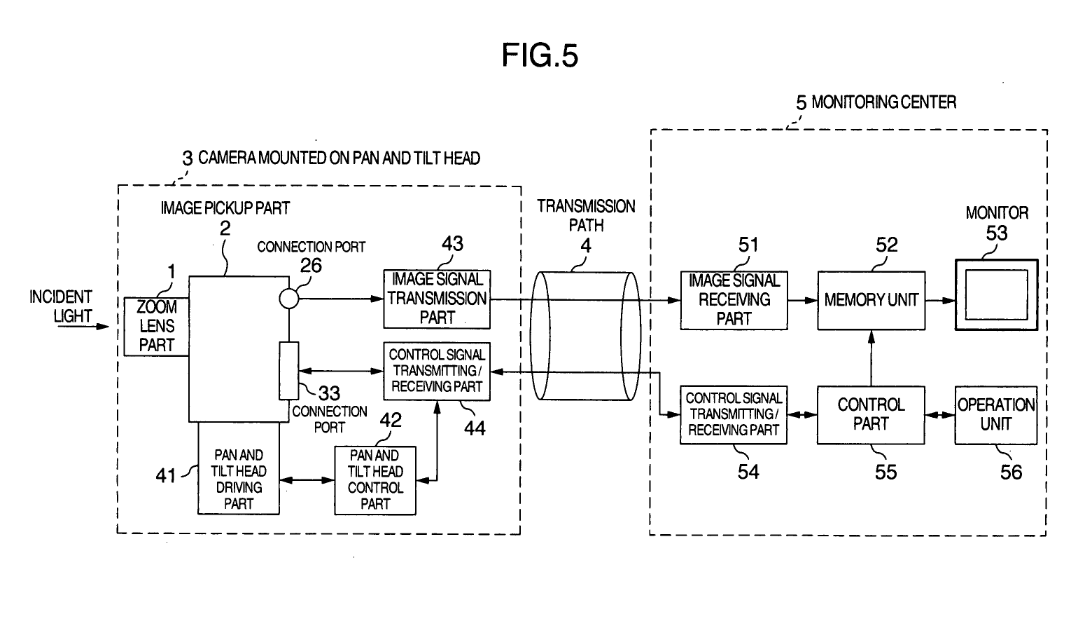

Referring now to FIG. 5, another embodiment of the present invention is described.

When the camera is operated to take images of various objects to be imaged, the taken images have coloring different depending on the objects. For example, when an image of a road is taken (on condition that the camera is set to have a pan angle, a tilt angle and a zoom magnification), the greater part of the image is occupied by gray (achromatic), while when an image of a forest is taken (on condition that the camera is set to another pan angle, another tilt angle and another zoom magnification), the greater part of the image is occupied by green. Accordingly, correction values of white balance are different in each case. Thus, the embodiment is directed to the television camera system which can correct white balance for R, G and B in consideration of a pan angle, a tilt angle and a zoom magnification of the camera mounted on a pan and tilt head

FIG. 5 is a block diagram schematically illustrating the television camera system of the embodiment.

In FIG. 5, the zoom lens part 1, the image pickup part 2, the connection ports 26 and 33 are the same as those of FIG. 1 and description thereof is omitted.

Numeral 3 denotes a camera including the zoom lens part 1 and the image pickup part 2 mounted in a pan and tilt head, 5 a monitoring center which remotely controls the camera 3 to monitor an image signal outputted from the camera 3, and 4 a transmission path connecting the camera 3 and the monitoring center 5.

In the camera 3, numeral 41 denotes a pan and tilt head driving part for revolving the zoom lens part 1 and the image pickup part 2, 42 a pan and tilt head control part for controlling the pan and tilt head driving part 41, 43 an image signal transmission part for transmitting the image signal outputted from the connection port 26 to the monitoring center 5, and 44 a control signal transmitting/receiving part for transmitting and receiving control signals between the camera 3 and the monitoring center 5.

In the monitoring center 5, numeral 56 denotes an operation unit for allowing the operator to remotely operate the camera 3, 55 a control part for converting signals supplied from the operation unit 56 into control signals for controlling the camera 3, 54 a control signal transmitting/receiving part for transmitting and receiving control signals between the monitoring center 5 and the camera 3, 51 an image signal receiving part for receiving the image signal transmitted through the transmission path 4 from the image signal transmission part 43 of the camera 3, 52 a memory unit for storing the image signal received by the image signal receiving part 51 and control data outputted from the control part 55, and 53 a monitor for displaying the image signal outputted from the memory unit 52.

Referring now to FIGS. 5 to 7, operation of FIG. 5 is described.

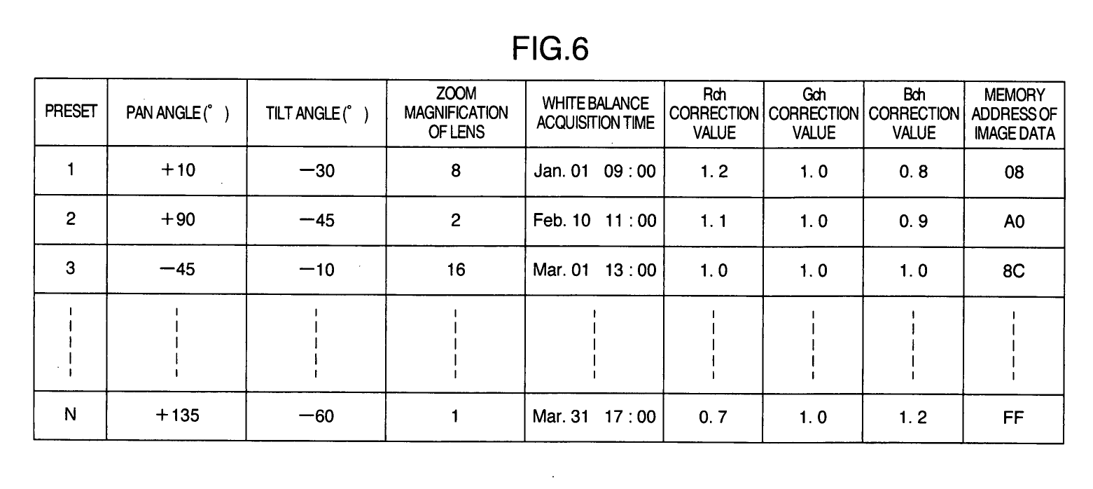

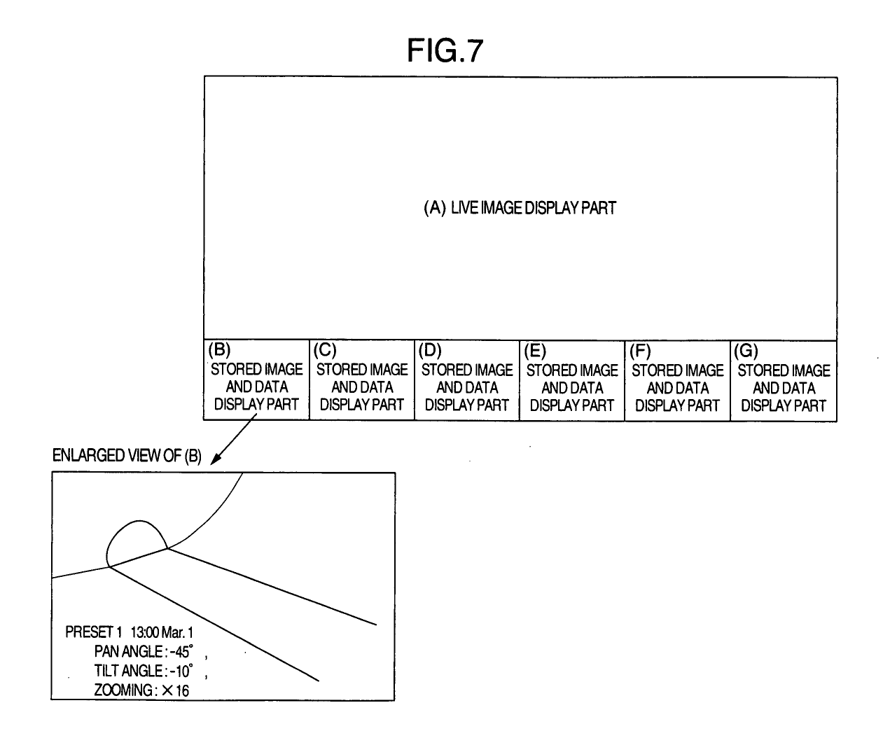

FIG. 6 is a memory map explaining the contents stored in the memory 30 of the image pickup part 2 and the memory unit 52. FIG. 7 is a diagram for explaining displayed contents in the monitor 53 of the image stored in the memory unit 52 and the image signals received by the image signal receiving part 51.

In order to get correction values of white balance for the angles of field of the camera 3 under illumination of sunlight to be stored in the memory 30 of the image pickup part 2, the operator of the monitoring center 5 operates the operation unit 56 to set the camera 3 to +10° for the pan angle, −30° for the tilt angle and 8 magnifications for the zoom magnification of the zoom lens part 1 as set in the preset value 1 of FIG. 6. The sign + of the pan angle represents the clockwise direction with regard to the reference point and the sign − represents the counterclockwise direction with regard to the reference point. Further, the sign + of the tilt angle represents the upward direction with regard to the reference point and the sign − represents the downward direction with regard to the reference point. The instruction signal for storing the correction values outputted from the white balance correction circuit 32 at the angle of field, the time that the white balance correction data is acquired, the angle of field, the image data and the address in which the image data is stored in the memory 32 of the image pickup part 2 is inputted from the operation unit 56 and is supplied through the control part 55, the control signal transmitting/receiving part 54 and the transmission path 4 to the control signal transmitting/receiving part 44 of the camera 3. The instruction signal supplied to the control signal transmitting/receiving part 44 is inputted to the connection port 33 and the pan and tilt head control part 42. The pan and tilt head control part 42 controls the pan and tilt head driving part 41 in accordance with the inputted instruction signal to set the camera 3 to the position decided by the pan angle of +10° and the tilt angle of −30°. The instruction signal inputted to the connection port 33 is supplied to the CPU 29. The CPU 29 gets the time signal from the clock circuit 31 and the correction signal from the white balance correction circuit 32 in accordance with the instruction signal and stores the signals in the memory 30.

Next, operation for making coloring of the image signal outputted from the image pickup part 2 equal to that gotten by sunlight in the day when the illumination is changed to a fluorescent lamp in the night is described.

The operator of the monitoring center 5 inputs an instruction signal set in the preset value 1, for example, by means of the operation unit 56 in order to make coloring of the image signal outputted from the image pickup part 2 equal to that gotten by illumination of sunlight in the day. The instruction signal is inputted to the pan and tilt head control part 42 and the connection port 33 of the camera 3 in the same manner as described above. The pan and tilt head control part 42 controls the pan and tilt head driving part 41 in accordance with the inputted instruction signal to set the camera 3 to the position decided by the pan angle of +10° and the tilt angle of −30°. The instruction signal inputted to the connection port 33 is supplied to the CPU 29. The CPU 29 reads out the preset value 1, for example, stored in the memory 30 in accordance with the inputted instruction signal and sets the zoom magnification of the zoom lens part 1 to be 8. Further, the CPU 29 supplies the instruction signal to the white balance correction circuit 32. The white balance correction circuit 32 detects an image in a part near to white from the image signal levels of the digital image signals of R, G and B outputted from the image processing circuit 24 and outputs correction signals for modifying the amplification factors of the AMPs 18, 19 and 20 in accordance with the data in the preset value 1 read out from the memory 30 through the CPU 29 in order to make coloring of the image in the part near to white equal to that gotten by illumination of sunlight. By repeating a series of modification operation of the amplification factors of the AMPs 18, 19 and 20, the digital image signals of R, G and B outputted from the image processing circuit 24 can get the same coloring as that gotten by the illumination of sunlight.

Referring now to FIG. 7, still another embodiment of the present invention is described.

FIG. 7 illustrates the contents displayed in the monitor 53 of FIG. 5. In FIG. 7, part (A) represents a live image part in which the image signal transmitted from the camera 3 is displayed and parts (B) to (G) represent stored image and data display parts in which data and image stored in the memory unit 52 are displayed for each preset number.

Displayed in an enlarged view of part (B) are the preset number, the date and time and image at the time that the correction value of white balance is acquired, the pan angle, the tilt angle and the zoom magnification of the zoom lens part 1 of the camera 3.

The operator of the monitoring center 5 can display the stored images in the stored image and data display parts (B) to (G) in the ascending order of the pan angles from the data stored in the memory unit 52 and accordingly can view the stored images as panoramic images.

In the embodiment, the incident light is separated into red (R), green (G) and blue (B) light of the three primary colors by means of the color separation prism named three-chip type and color image signals are produced by three image pickup devices, although the incident light may be separated into four or more colors by means of a color separation prism to produce the color image signals. Further, a one-chip color image pickup device may be used to produce the color image signals.

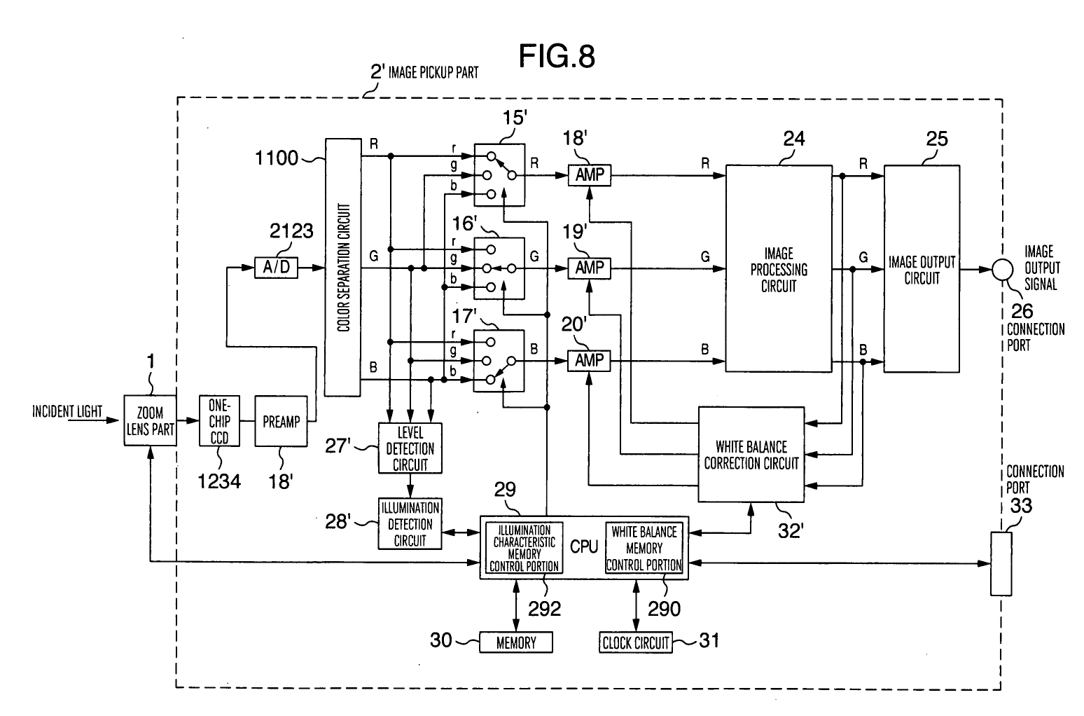

FIG. 8 is a block diagram schematically illustrating another embodiment of a television camera which produces color image signals by means of a one-chip color image pickup device.

In FIG. 8, numeral 2′ denotes an image pickup part for converting light incident from the zoom lens part 1 into image signal.

In the image pickup part 2′, numeral 1234 denotes a one-chip color image pickup device (hereinafter referred to as one-chip CCD) for converting incident light passing through the zoom lens part 1 into a color image signal. The image signal from the one-chip CCD 1234 is inputted to a preamplifier 18′, which amplifies the image signal to be matched to an input level of an analog-to-digital (A-D) converter 2123 at the next stage. The amplified image signal is converted into a digital image signal by the A-D converter 2123 to be supplied to a color separation circuit 1100, which separates the digital image signal into digital image signals of R, G and B. The separated digital image signals of R, G and B are supplied to switches 15′, 16′ and 17′, respectively, in the same manner as the embodiment of FIG. 1. Further, in the same manner as the embodiment of FIG. 1, the AMP 18′ amplifies the image signal supplied from the switch 15′ to a predetermined level, an AMP 19′ amplifies the image signal supplied from the switch 16′ to a predetermined level and an AMP 20′ amplifies the image signal supplied from the switch 17′ to a predetermined level. Output signals of the AMPs 18′, 19′ and 20′ are inputted to the image processing circuit 24 to be subjected to processing such as color correction and contour emphasis. The subsequent configuration and operation are the same as those of the embodiment of FIG. 1 and description thereof is not required, noting that in the present embodiment the switches 15′-17′, AMPs 18′-20′, level detection circuit 27′, illumination detection circuit 28′, white balance correction circuit 32′ may be constituted by digital circuits since the signals handled therein are digital signals.

The present invention has been described in detail as above, although it is needless to say that the present invention is not limited to the television camera as described above and can be widely applied to other television cameras except the above.

It should be further understood by those skilled in the art that although the foregoing description has been made on embodiments of the invention, the invention is not limited thereto and various changes and modifications may be made without departing from the spirit of the invention and the scope of the appended claims.

1. A television camera comprising:
a color separation optical element for color-separating light incident from an image pickup lens into light of at least three colors;
a plurality of image pickup devices for converting the color-separated light into electrical image signals to be outputted;
a white balance correction circuit for correcting signal levels of the image signals of three colors to be the same signal level;
a clock circuit for generating or acquiring a time point;
a white balance memory circuit for storing correction values of the white balance correction circuit together with the acquisition time point thereof obtained from the clock circuit;
a level detection circuit for detecting signal levels of the image signals produced from the plurality of image pickup devices;
an illumination characteristic memory circuit for storing wavelength characteristics of a plurality of illumination lamps; and
an illumination detection circuit for identifying kind of illumination on the basis of the signal levels detected by the level detection circuit and the wavelength characteristics of the illumination lamps stored in the illumination characteristic memory circuit;
wherein the correction values of the white balance correction circuit are modified on the basis of an output of the illumination detection circuit and an output of the white balance memory circuit.

2. A television camera according to claim 1, further comprising:
an image processing circuit for subjecting the image signals of three colors to predetermined image processing; and
switches for switching the image signals of three colors produced from the image pickup devices to be supplied to the image processing circuit, the switches being switched in accordance with the output of the illumination detection circuit.

3. A television camera system comprising:
a pan and tilt head; and
an image pickup part mounted on the pan and tilt head;
the image pickup part including:
an image pickup zoom lens;
a color separation optical element for color-separating light incident from the image pickup lens into light of at least three colors;
a plurality of image pickup devices for converting the color-separated light into electrical image signals to be outputted;
a white balance correction circuit for correcting signal levels of the image signals of three colors to be the same signal level;
a clock circuit for generating or acquiring the time point;
a white balance memory circuit for storing correction values of the white balance correction circuit together with the acquisition time point thereof obtained from the clock circuit, the white balance memory circuit further storing a pan angle and a tilt angle of the pan and tilt head and a zoom magnification of the image pickup zoom lens in association with the correction values and the acquisition time thereof;
a level detection circuit for detecting signal levels of the image signals produced from the plurality of image pickup devices;
an illumination characteristic memory circuit for storing wavelength characteristics of a plurality of illumination lamps; and
an illumination detection circuit for identifying kind of illumination on the basis the signal levels detected by the level detection circuit and the wavelength characteristics of the illumination lamps stored in the illumination characteristic memory circuit;
wherein the correction values of the white balance correction circuit are modified on the basis of an output of the illumination detection circuit and an output of the white balance memory circuit.

4. A television camera system according to claim 3, wherein
the image pickup part further includes:
an image processing circuit for subjecting the image signals of three colors to predetermined image processing; and
switches for switching the image signals of three colors produced from the image pickup devices to be supplied to the image processing circuit, the switches being switched in accordance with the output of the illumination detection circuit.

5. A television camera comprising:
an image pickup device for converting light incident from an image pickup lens into an electrical color image signal to be outputted;
a separation circuit for separating the color image signal into red, green and blue image signals;
a white balance correction circuit for correcting signal levels of the red, green and blue image signals to be the same signal level;
a clock circuit for generating or acquiring the time point;
a white balance memory circuit for storing correction values of the white balance correction circuit together with acquisition time point thereof obtained from the clock circuit;
a level detection circuit for detecting signal levels of the red, green and blue image signals produced from the color separation circuit;
an illumination characteristic memory circuit for storing wavelength characteristics of a plurality of illumination lamps; and
an illumination detection circuit for identifying kind of illumination on the basis of the signal levels detected by the detection circuit and the wavelength characteristics of the illumination lamps stored in the illumination characteristic memory circuit;
wherein the correction values of the white balance correction circuit are modified on the basis of an output of the illumination detection circuit and an output of the white balance memory circuit.

6. A television camera according to claim 5, further comprising:
an image processing circuit for subjecting the red, green and blue image signals to predetermined image processing; and
switches for switching the red, green and blue image signals produced from the color separation circuit to be supplied to the image processing circuit, the switches being switched in accordance with the output of the illumination detection circuit.

7. A television camera system comprising:
a pan and tilt head; and
an image pickup part mounted on the pan and tilt head;
the image pickup part including:
an image pickup zoom lens;
an image pickup device for converting incident light from the image pickup lens into an electrical color image signal to be outputted;
a separation circuit for separating the color image signal into red, green and blue image signals;
a white balance correction circuit for correcting signal levels of the red, green and blue image signals to be the same signal level;
a clock circuit for generating or acquiring the time point;
a white balance memory circuit for storing correction values of the white balance correction circuit together with the acquisition time thereof obtained from the clock circuit, the white balance memory circuit further storing a pan angle and a tilt angle of the pan and tilt head and a zoom magnification of the image pickup zoom lens in association with the correction values and the acquisition time thereof;
a level detection circuit for detecting signal levels of the red, green and blue image signals produced from the separation circuit;
an illumination characteristic memory circuit for storing wavelength characteristics of a plurality of illumination lamps; and
an illumination detection circuit for identifying kind of illumination on the basis of the signal levels detected by the detection circuit and the wavelength characteristics of the illumination lamps stored in the illumination characteristic memory circuit;
wherein the correction values of the white balance correction circuit are modified on the basis of an output of the illumination detection circuit and an output of the white balance memory circuit.

8. A television camera system according to claim 7, wherein
the image pickup part further includes:
an image processing circuit for subjecting the red, green and blue image signals to predetermined image processing; and
switches for switching the red, green and blue image signals from the separation circuit to be supplied to the image processing circuit, the switches being switched in accordance with the output of the illumination detection circuit.

9. An image pickup control method in a television camera including one or a plurality of image pickup devices for producing image signals of three colors and a white balance correction circuit supplied with the image signals of three colors, comprising:
taking an image of an object to be imaged by the image pickup devices;
identifying by an illumination detection unit a kind of illumination illuminating the object;
modifying correction values of the white balance correction circuit in accordance with the identified kind of illumination; and
subjecting corrected image signals to predetermined image processing to produce an image output signal.

10. An image pickup control method according to claim 9, wherein
the white balance correction circuit automatically modifies the correction values in response to detection of change of the kind of illumination by the illumination detection unit.

11. An image pickup control method according to claim 9, wherein
the white balance correction circuit automatically modifies the correction values in response to an instruction of an operator.

12. An image pickup control method according to claim 9, wherein
there are sunlight and at least two kinds of illumination selected from a plurality of artificial light as the kind of illumination.

13. An image pickup control method according to claim 9, further comprising:
storing at least one set of white balance correction values in sunlight in a memory previously.

14. An image pickup control method according to claim 13, further comprising:
causing the white balance correction circuit to read out a white balance correction value in sunlight for one image signal of the three color image signals from the memory when the identified kind of illumination indicates artificial light having substantially single wavelength and produce three color image signals by means of the read-out white balance correction value.

15. An image pickup control method according to claim 14, wherein
the artificial light having substantially single wavelength contains light emitted by a sodium lamp.

16. An image pickup control method according to claim 13, further comprising:
causing the white balance correction circuit to read out a white balance correction value in sunlight for one image signal of the three color image signals from the memory when the identified kind of illumination indicates light emitted by a fluorescent lamp and produce three color image signals by means of the read-out white balance correction value.

17. An image pickup control method according to claim 9, wherein
the television camera includes a pan and tilt head and an image pickup zoom lens; and
the step of modifying the correction values of the white balance correction circuit comprises:
storing previously in a memory as preset values at least one set of parameters including a pan angle and a tilt angle of the pan and tilt head, a zoom magnification, white balance correction values in sunlight and acquisition time of the white balance correction values.

18. An image pickup control method according to claim 17, further comprising:
reading out one set of parameters stored as the preset values in response to operator's designation of specific preset values and controlling the pan and tilt head, the image pickup zoom lens and the white balance correction circuit on the basis of the read-out parameters.
